(19) United States
(12) Patent Application Publication
(10) Pub. No.: US 2023/0148045 A1
(43) Pub. Date: May 11, 2023

(54) AERIAL IMAGE PROJECTOR AND MOVABLE BODY

(71) Applicant: KYOCERA Corporation, Kyoto-shi, Kyoto (JP)

(72) Inventors: Kazuki SHIMOSE, Yasu-shi, Shiga (JP); Hiroyoshi KAWANISHI, Sanda-shi, Hyogo (JP)

(21) Appl. No.: 18/010,729

(22) PCT Filed: Jun. 1, 2021
(86) PCT No.: PCT/JP2021/020845

§ 371 Date: Dec. 15, 2022

(30) Foreign Application Priority Data
Jun. 19, 2020 (JP) 2020-106285

(51) Int. Cl. G02B 30/56; G02B 30/32

(52) U.S. Cl. CPC G02B 30/56; G02B 30/32; G02B 5/3058

(57) ABSTRACT

An aerial image projector includes a first reflective element, a second reflective element, a first optical element, a display device, and a second optical element. The first reflective element transmits, in a second direction, a part of first image light traveling in a first direction and reflects, in a third direction, a part of second image light traveling in the second direction. The second reflective element retroreflects the first image light transmitted through the first reflective element as the second image light. The first optical element is between the first reflective element and the second reflective element. The first optical element collects the first image light and collects the second image light. The display device emits the first image light. The second optical element divides a beam of the first image light emitted from the display device into at least two light beams.

### TECHNICAL FIELD

The present disclosure relates to an aerial image projector and a movable body.

### BACKGROUND OF INVENTION

A known technique is described in, for example, Patent Literature 1.

### CITATION LIST

### Patent Literature

Patent Literature 1: Japanese Unexamined Patent Application Publication No. 2011-253128

### SUMMARY

In one embodiment of the present disclosure, an aerial image projector includes a first reflective element, a second reflective element, a first optical element, a display device, and a second optical element. The first reflective element transmits, in a second direction, a part of first image light traveling in a first direction and reflects, in a third direction, a part of second image light traveling in the second direction. The second reflective element retroreflects the first image light transmitted through the first reflective element as the second image light. The first optical element is between the first reflective element and the second reflective element. The first optical element collects the first image light and the second image light. The display device is located apart from the first reflective element in the first direction. The display device emits the first image light. The second optical element divides a beam of the first image light emitted from the display device into at least two light beams.

In one embodiment of the present disclosure, a movable body includes the aerial image projector described above.

### BRIEF DESCRIPTION OF THE DRAWINGS

The objects, features, and advantages of the present disclosure will become more apparent from the following detailed description and the drawings.

FIG. 1 is a schematic diagram of an example aerial image projector.

FIG. 2 is a schematic diagram of a display device illustrated in FIG. 1.

FIG. 3 is a diagram describing the relationship between an aerial image and a user's eyes illustrated in FIG. 1.

FIG. 4 is a schematic diagram of another example aerial image projector.

FIG. 5 is a schematic diagram of still another example aerial image projector.

FIG. 6 is a schematic diagram of still another example aerial image projector.

FIG. 7 is a schematic diagram of still another example aerial image projector.

FIG. 8 is a schematic diagram of still another example aerial image projector.

FIG. 9 is a schematic diagram of still another example aerial image projector.

FIG. 10 is a schematic diagram of still another example aerial image projector.

FIG. 11 is a schematic diagram of an example movable body on which an aerial image projector is mounted.

### DESCRIPTION OF EMBODIMENTS

Various aerial image projectors have been developed to form an aerial image from image light emitted from a display device with the structure that forms the basis of the present disclosure.

One or more embodiments of the present disclosure will now be described with reference to the drawings. The drawings used herein are schematic and are not drawn to scale relative to the actual size of each component in the drawings.

An aerial image projector 1 includes a first reflective element 2, a second reflective element 3, a first optical element 5, a display device 8, and a second optical element 6.

The display device 8 may include a transmissive display device or a self-luminous display device. For example, the transmissive display device may be a liquid crystal display device. For example, the self-luminous display device may be a display device including a self-luminous element such as a light-emitting diode (LED) element, an organic electroluminescent (OEL) element, an organic LED (OLED) element, or a semiconductor laser diode (LD) element.

In the present embodiment, the display device 8 includes a liquid crystal display device. The display device 8 includes a backlight 81 and a liquid crystal panel 82. The display device 8 includes a display surface 8a, which emits first image light (hereafter referred to as first light) L1 representing an image. The display device 8 emits the first light L1 in a first direction D1. The first light L1 may be image light that represents a moving image or a still image.

The backlight 81 may include multiple light sources that face the display surface 8a and are arranged two-dimensionally adjacent to a back surface opposite to the display surface 8a. The light sources may be, for example, LEDs, cold cathode fluorescent lamps, halogen lamps, or xenon lamps. The backlight 81 including light sources that face the display surface 8a and are arranged adjacent to the back surface opposite to the display surface 8a can be referred to as a direct backlight. The backlight 81 may include multiple light sources arranged on the outer periphery of the liquid crystal panel 82 to guide light to the entire back surface opposite to the display surface 8a using a light guide plate. The backlight 81 including the light sources arranged on the outer periphery of the liquid crystal panel 82 can be referred to as an edge backlight. The backlight 81 may include, for example, a lens array, a light guide plate, and a diffusion plate to apply light from the light sources uniformly onto the display surface 8a.

The liquid crystal panel 82 may have the structure of a known liquid crystal panel. The known liquid crystal panel herein may be an in-plane switching (IPS) panel, a fringe field switching (FFS) panel, a vertical alignment (VA) panel, an electrically controlled birefringence (ECB) panel, or any of various other liquid crystal panels. The liquid crystal panel 82 may include a first polarizing plate, a color filter substrate, a liquid crystal layer, an array substrate, and a second polarizing plate. The first polarizing plate may be located adjacent to the display surface 8a of the display device 8.

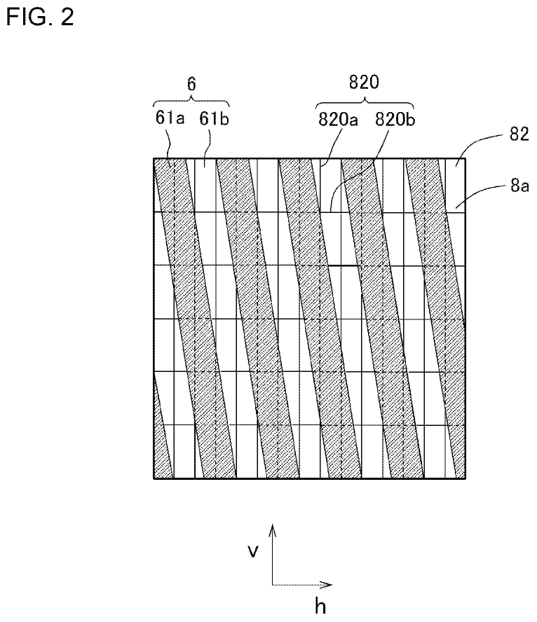

As illustrated in, for example, FIG. 2, the liquid crystal panel 82 has multiple divisional areas defined by a black matrix 820 in a grid in the horizontal direction and the vertical direction on a plate-like surface. The divisional areas may be the display surface 8a. Each divisional area corresponds to a subpixel. The black matrix includes first black lines 820a extending in the vertical direction and second black lines 820b extending in the horizontal direction that define the divisional areas. In the black matrix 820, multiple first black lines 820a are arranged in the horizontal direction with, for example, a constant pitch, and multiple second black lines 820b are arranged in the vertical direction with, for example, a constant pitch. Multiple subpixels are arranged in a matrix in the horizontal direction and the vertical direction. Each subpixel has one of the colors red (R), green (G), and blue (B). One pixel may be a set of three subpixels with R, G, and B. A pixel may be referred to as a picture element. For example, multiple subpixels included in one pixel are arranged in the horizontal direction. For example, subpixels having the same color are arranged in the vertical direction. In FIG. 2, the horizontal direction refers to h-direction, and the vertical direction refers to v-direction.

The first reflective element 2 is located apart from the display device 8 in the first direction D1. In other words, the display device 8 is located apart from the first reflective element 2 in the first direction D1. The first reflective element 2 transmits, in a second direction D2, at least a part of the first light L1 traveling in the first direction D1. The first reflective element 2 may reflect the remaining part of the first light L1. The first reflective element 2 reflects, in a third direction D3, at least a part of second image light (hereafter referred to as second light) L2 traveling in the second direction D2. The first reflective element 2 may transmit the remaining part of the second light L2. The second light L2 may be image light that represents an image similarly to the first light L1.

The first light L1 may be parallel light traveling in the first direction D1 or light traveling in a direction substantially parallel to the first direction D1. The first light L1 may be light traveling mainly in the first direction D1. The second light L2 may be parallel light traveling in the second direction D2 or light traveling in a direction substantially parallel to the second direction D2. The second light L2 may be light traveling mainly in the second direction D2. The first reflective element 2 may reflect a part of the second light L2 as parallel light traveling in the third direction D3 or reflect a part of the second light L2 as light traveling in a direction substantially parallel to the third direction D3. The first reflective element 2 may reflect a part of the second light L2 as light traveling mainly in the third direction D3. The traveling direction of light herein refers to a substantial traveling direction of light. The traveling direction of light herein also refers to the main traveling direction of light.

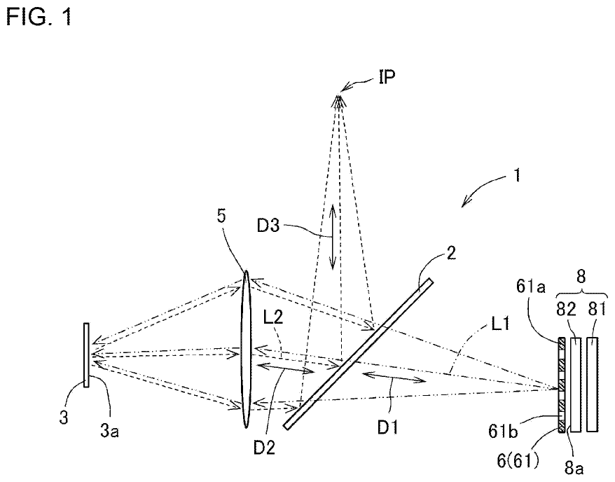

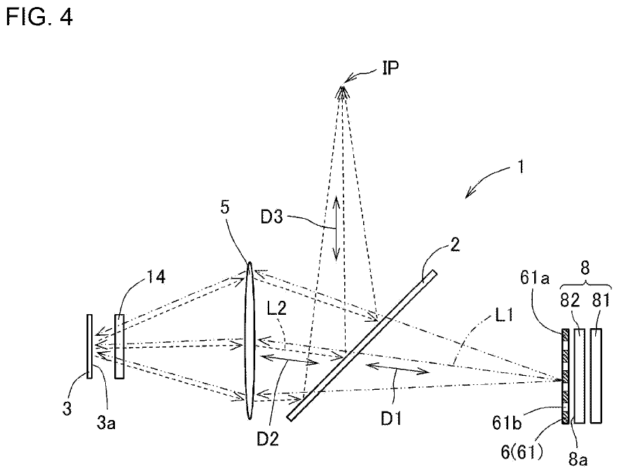

In the example illustrated in FIG. 1, the first light L1 emitted from the display device 8 travels in the first direction D1 and is incident on the first reflective element 2. For ease of illustration, in FIG. 1, the traveling path of light emitted from one pixel included in the display device 8 is illustrated. The same applies to FIGS. 4 to 10 described later. The traveling path may be referred to as a light path.

The first reflective element 2 is located on the light path of the first light L1 emitted from the display device and located on the light path of the second light L2 traveling in the second direction D2. The first reflective element 2 may include a reflective polarizer. The reflective polarizer may be, for example, a semi-reflective mirror, a wire-grid polarizer, a reflective polarizing plate, or a beam splitter. For the first reflective element 2 being a polarizing plate, the transmitted first light L1 is polarized linearly or slightly elliptically along a transmission axis of the first reflective element 2. The first reflective element 2 may be a wire-grid polarizer including a light transmissive substrate and multiple metal wires on a surface of the light transmissive substrate. The light transmissive substrate may be, for example, a triacetyl cellulose (TAC) film, a polyethylene terephthalate (PET) film, or a cycloolefin polymer (COP) film. The metal wires may be made of, for example, a metal material such as aluminum, chromium, or titanium oxide.

The second reflective element 3 retroreflects the first light L1 transmitted through the first reflective element 2. The second light L2 is reflected light that is the first light L1 transmitted through the first reflective element 2 and reflected by the second reflective element 3. The second reflective element 3 may be located apart from the first reflective element 2 in the second direction D2.

The second reflective element 3 may include a retroreflective element, which is also referred to as a retroreflector. The retroreflective element includes, for example, a corner cube retroreflective element and a microbead retroreflective element.

The first optical element 5 is located between the first reflective element 2 and the second reflective element 3 as illustrated in, for example, FIG. 1. The first optical element 5 is located on the light path of the first light L1 transmitted through the first reflective element 2 and located on the light path of the second light L2 reflected by the second reflective element 3.

The first optical element 5 collects light. The first optical element 5 collects the first light L1 transmitted through the first reflective element 2. The first optical element 5 collects the second light L2 retroreflected by the second reflective element 3. The first optical element 5 may include, for example, one or more lenses or one or more mirrors.

The first optical element 5 may include a biconvex lens or a Fresnel lens. The lens surface of the biconvex lens may be at least partially spherical, at least partially aspherical, or at least partially freeformed. For the first optical element 5 being a Fresnel lens, the first optical element 5 can be thinner. The aerial image projector 1 can thus be compact. Each refractive portion of the Fresnel lens may be at least partially spherical, at least partially aspherical, or at least partially freeformed.

The first optical element 5 may include, for example, two plano-convex lenses arranged in the second direction D2. The two plano-convex lenses may be arranged with their convex lens surfaces facing each other or with their flat lens surfaces facing each other. The convex lens surface of the plano-convex lens may be at least partially spherical, at least partially aspherical, or at least partially freeformed. In some embodiments, the first optical element 5 may include three lenses or four or more lenses, instead of one lens or two lenses.

The first optical element 5 may include, on a part of or on a full portion of the lens surface, an anti-reflection (AR) coating layer that reduces the reflection of at least one of the first light L1 or the second light L2 on the lens surface. This structure can increase the light use efficiency of the aerial image projector 1.

The second optical element 6 divides a beam of the first light L1 emitted from the display device 8 into at least two light beams. The light beam may be referred to as a light ray. The second optical element 6 divides the beam of the first light L1 emitted from the display device 8 into a beam of first partial light L1L to be incident on a first eye (left eye) 13L of a user 12 and a beam of second partial light L1R to be incident on a second eye (right eye) 13R of the user 12. The second optical element 6 may be located between the display device 8 and the first reflective element 2 in the first direction D1. The second optical element 6 may include, for example, a parallax barrier, a lenticular lens, or a microlens array.

In the present embodiment, the aerial image projector 1 includes the second optical element 6 including a parallax barrier 61. As illustrated in, for example, FIG. 1, the parallax barrier 61 may be adjacent to the display surface 8a of the display device 8. The parallax barrier 61 may be located at a predetermined distance from the display surface 8a. The parallax barrier 61 is located opposite to the backlight 81 from the liquid crystal panel 82. The parallax barrier may be located between the backlight 81 and the liquid crystal panel 82.

As illustrated in, for example, FIGS. 1 to 3, the parallax barrier 61 includes multiple light-blocking portions 61a. The light-blocking portions 61a block the image light emitted from the display device 8. The light-blocking portions 61a define open areas 61b between adjacent light-blocking portions 61a. The open areas 61b have a higher light transmittance than the light-blocking portions 61a. The light-blocking portions 61a have a lower light transmittance than the open areas 61b.

The open areas 61b are parts of the parallax barrier to transmit light incident on the parallax barrier. The open areas 61b may transmit light with a transmittance of a first predetermined value or greater. The first predetermined value may be, for example, 100% or a value close to 100%. The light-blocking portions 61a are parts of the parallax barrier to block light incident on the parallax barrier. In other words, the light-blocking portions 61a block an image displayed by the display device 8. The light-blocking portions 61a may block light with a transmittance of a second predetermined value or less. The second predetermined value may be, for example, 0% or a value close to 0%. The ratio of the second predetermined value to the first predetermined value may be 1/100 or 1/1000.

The light-blocking portions 61a and the open areas 61b are arranged alternately in the horizontal direction and the vertical direction as illustrated in, for example, FIG. 2. For open areas 61b having their ends indicated by lines extending in the vertical direction, moire is likely to occur in a viewing image due to an error included in the arrangement of the subpixels or the dimensions of the open areas 61b. For open areas 61b having their ends indicated by lines extending at a predetermined angle with respect to the vertical direction, moire is less likely to occur in a viewing image independently of an error included in the arrangement of the subpixels or the dimensions of the open areas 61b.

The parallax barrier 61 may be a film or a plate with a transmittance less than the second predetermined value. In this case, the light-blocking portions 61a are parts of the film or plate. The open areas 61b are slits in the film or plate. The film may be made of resin or another material. The plate may be made of, for example, resin, metal, or another material. The parallax barrier 61 may be a member other than a film or a plate. The parallax barrier 61 may include a base made of a light-blocking material or of a material containing an additive with light-blocking properties.

The parallax barrier 61 may be, for example, a liquid crystal shutter. The liquid crystal shutter can control the light transmittance in accordance with a voltage applied. The liquid crystal shutter may include multiple pixels and control the transmittance of light for each pixel. The liquid crystal shutter can form a portion with a high light transmittance or a portion with a low light transmittance in an intended shape. For the parallax barrier 61 being a liquid crystal shutter, the open areas 61b may have a transmittance of the first predetermined value or greater. For the parallax barrier 61 being a liquid crystal shutter, the light-blocking portions 61a may have a transmittance of the second predetermined value or less.

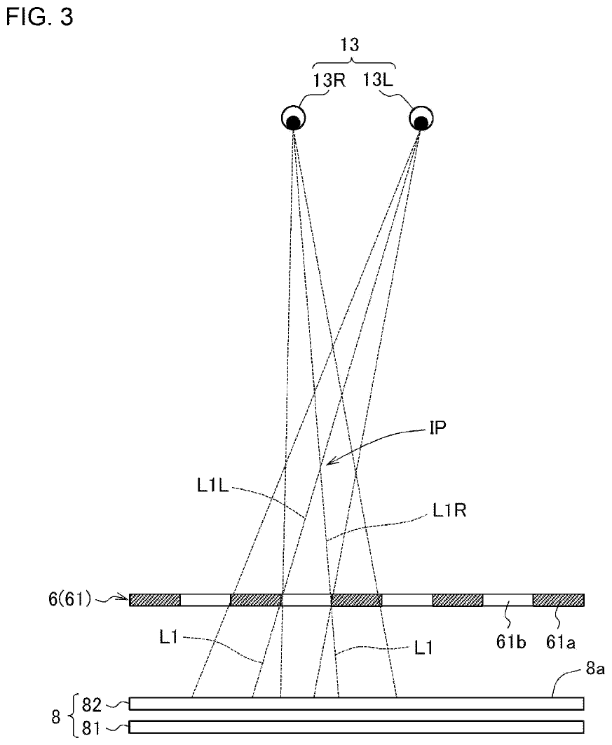

Referring to FIG. 3, the optical function of the parallax barrier 61 will be described. FIG. 3 illustrates a part of the beam of the first light L1 emitted from the display device 8, a part of the beam of the first partial light L1L to be incident on the left eye 13L of the user 12, and a part of the beam of the second partial light L1R to be incident on the right eye 13R of the user 12. For ease of illustration, in FIG. 2, components other than the display device 8 and the parallax barrier 61 in the aerial image projector 1 are not illustrated.

The display surface 8a of the display device 8 emits the first light L1 that represents a parallax image in the first direction D1. The parallax image refers to an image projected to the left eye 13L and the right eye 13R of the user 12 to cause parallax between the eyes 13L and 13R of the user 12. As illustrated in, for example, FIG. 2, the parallax barrier 61 divides the beam of the first light L1 into the beam of the first partial light L1L and the beam of the second partial light L1R. The first partial light L1L and the second partial light L1R travel in the first direction D1.

As described below, the first partial light L1L and the second partial light L1R form an image at an imaging position IP with the optical functions of the first reflective element 2, the second reflective element 3, and the first optical element 5. The user 12 observes the first partial light L1L with the left eye 13L and the second partial light L1R with the right eye 13R to view a three-dimensional aerial image resulting from binocular parallax.

The aerial image projector 1 may include a controller. The controller is connected to the components of the aerial image projector 1 and controls the components. The controller may be, for example, a processor. The controller may include one or more processors. The processors may include a general-purpose processor that reads a specific program and performs a specific function and a processor dedicated to specific processing. The dedicated processor may include an application-specific integrated circuit (ASIC). The processors may include a programmable logic device (PLD). The PLD may include a field-programmable gate array (FPGA). The controller may be either a system on a chip (SoC) or a system in a package (SiP) in which one or more processors cooperate with other components. The controller may include a storage for storing various information sets or a program for causing each component of the aerial image projector 1 to operate. The storage may be, for example, a semiconductor memory. The storage may serve as a work memory for the controller.

Referring to FIGS. 1 and 3, the formation of an aerial image performed by the aerial image projector 1 will be described. The first light L1 emitted from the display device 8 in the first direction D1 passes through the second optical element 6. The first light L1 travels in the first direction D1 with the beam of the first light L1 being divided into the beam of the first partial light L1L and the beam of the second partial light L1R by the second optical element 6. The first partial light L1L is incident on the left eye 13L of the user 12, and the second partial light L1R is incident on the right eye 13R of the user 12. The image represented by the first partial light L1L has parallax with the image represented by the second partial light L1R.

The first light L1 travels in the first direction D1 and reaches the first reflective element 2. A part of the first light L1 reaching the first reflective element 2 is transmitted through the first reflective element 2 and travels in the second direction D2. The first light L1 transmitted through the first reflective element 2 is collected by the first optical element 5 and reaches the second reflective element 3.

The first light L1 reaching the second reflective element 3 is retroreflected by the second reflective element 3 to be the second light L2. The second light L2 is collected by the first optical element 5 and reaches the first reflective element 2. A part of the second light L2 reaching the first reflective element 2 is reflected by the first reflective element 2 in the third direction D3. The part of the second light L2 reflected by the first reflective element 2 forms an image at the imaging position IP in the air.

The part of the second light L2 forming an image in the air includes left eye image light that is a part of the first partial light L1L and right eye image light that is a part of the second partial light L1R. The left eye image light represents a left eye image viewed by the left eye 13L of the user 12. The right eye image light represents a right eye image viewed by the right eye 13R of the user 12. The right eye image has parallax with the left eye image. The user 12 observes the left eye image with the left eye 13L and the right eye image with the right eye 13R to view a three-dimensional aerial image resulting from binocular parallax.

In the present embodiment, the aerial image projector 1 can form a three-dimensional aerial image as described above. This can increase the amount of information provided by the aerial image to the user as compared with when a two-dimensional aerial image is projected.

When a device that projects an aerial image using retroreflection from a retroreflective element causes image light for retroreflection to be incident on a wide area of a reflective surface of the retroreflective element, the image light may be affected by the size of a prism included in the retroreflective element and diffraction by the prism. In this case, the retroreflected image light may diffuse to form a blurry aerial image. The diffraction by the prism included in the retroreflective element affects the image light more noticeably when the distance between the display device and the retroreflective element is longer. In the present embodiment, the aerial image projector 1 includes the first optical element 5 that collects light between the display device 8 and the second reflective element 3. This structure allows light collected by the first optical element 5 to be incident on a relatively small area of a reflective surface 3a of the second reflective element 3. This reduces diffusion of the second light L2 retroreflected by the second reflective element 3. This thus increases the resolution of the aerial image and increases the amount of information presented by the aerial image to the user.

In the aerial image projector 1 according to the present embodiment, the first optical element 5 further collects the second light L2 retroreflected by the second reflective element 3 to allow the collected second light L2 to be incident on the first reflective element 2. This further reduces diffusion of the second light L2. This thus increases the resolution of the aerial image and increases the amount of information presented by the aerial image to the user.

The first optical element 5 is not limited to a biconvex lens or a Fresnel lens. The first optical element 5 may be a microlens array or a concave mirror.

The microlens array is an optical element including multiple microlenses arrayed on a substrate. The microlenses may be circular, rectangular, or polygonal as viewed in a direction orthogonal to the main surface of the substrate. The microlenses may be arranged regularly (specifically, in a matrix) or randomly. The lens surface of each microlens may be at least partially spherical or at least partially aspherical. The lens surface of each microlens may be at least partially freeformed. For the first optical element 5 being a microlens array, the arrangement of the microlenses and the shape and size of each of the microlenses can be adjusted to finely control the distribution of the first light L1 and the second light L2. This thus increases the resolution of the aerial image and increases the amount of information presented by the aerial image to the user.

The concave mirror reflects the first light L1 transmitted through the first reflective element 2 toward the second reflective element 3 and reflects the second light L2 retroreflected by the second reflective element 3 toward the first reflective element 2. The concave mirror is located to have its reflective surface facing the first optical element 5 and the second reflective element 3. The reflective surface of the concave mirror may be at least partially spherical or at least partially aspherical. The reflective surface of the concave mirror may be at least partially freeformed. For the first optical element 5 being a concave mirror, the aerial image projector 1 with a simple structure can increase the resolution of the aerial image and increase the amount of information presented by the aerial image to the user.

The second reflective element 3 may be located adjacent to a focal point of the first optical element 5. In this case, the first light L1 collected by the first optical element 5 is incident on a small area of the reflective surface 3a of the second reflective element 3, thus reducing diffusion of the second light L2. This can increase the resolution of the aerial image and increase the amount of information presented by the aerial image to the user 12.

The aerial image projector 1 may include the display device 8 located adjacent to a focus of the first optical element 5 and the second reflective element 3 located adjacent to a focus of the first optical element 5. In other words, the aerial image projector 1 may include the display device 8 and the second reflective element 3 located to be optically conjugated with each other. This allows an aerial image with high resolution to be projected at various positions in the air by simply translating or rotating the first reflective element 2.

The aerial image projector 1 may include a third optical element 14 as illustrated in, for example, FIG. 4. The third optical element 14 may be located between the second reflective element 3 and the first optical element 5. The third optical element 14 may be located adjacent to the reflective surface 3a of the second reflective element 3. The third optical element 14 may collect scattering light included in the second light L2. This structure can reduce diffusion of the second light L2 retroreflected by the second reflective element 3. This thus increases the resolution of the aerial image and increases the amount of information presented by the aerial image to the user.

The third optical element 14 may be, for example, a plano-convex lens, a biconvex lens, a meniscus lens, or a Fresnel lens. The third optical element 14 may include one or more lenses. The third optical element 14 may be, for example, a microlens array.

For the display device 8 being a liquid crystal display device, the first light L1 emitted from the display device 8 may be polarized linearly in the polarization direction of the first polarizing plate. For the first reflective element 2 being a reflective polarizing plate, first light L1 polarized along the transmission axis of the first reflective element 2 can reduce reflection from the first reflective element 2. The polarization direction of the first polarizing plate is, for example, along the transmission axis of the first reflective element 2.

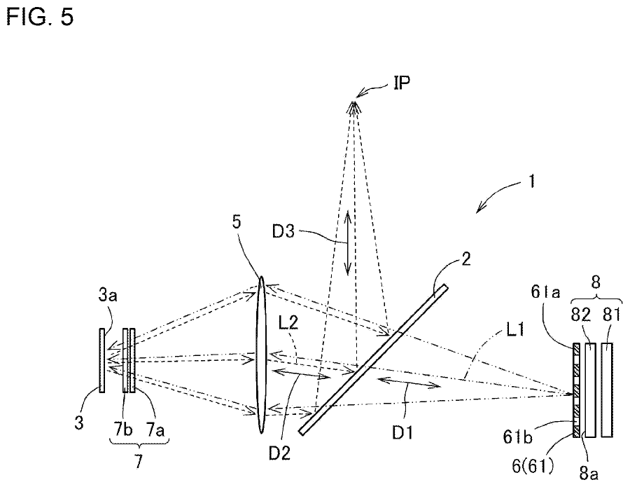

The aerial image projector 1 may include a phase difference plate 7 as illustrated in, for example, FIG. 5. The phase difference plate 7 may be located between the second reflective element 3 and the first optical element 5. The phase difference plate 7 may rotate the polarization direction of transmitted light. The phase difference plate 7 may be located adjacent to the reflective surface 3a of the second reflective element 3. The phase difference plate 7 may be located at a predetermined distance from the reflective surface 3a of the second reflective element 3.

For the first reflective element 2 being a polarizer, the first light L1 transmitted through the first reflective element 2 is polarized linearly or slightly elliptically along the transmission axis of the first reflective element 2. The polarized light or the second light L2 retroreflected by the second reflective element 3 may be polarized linearly or slightly elliptically in the polarization direction of the first reflective element 2. Thus, the second light L2 incident on the first reflective element 2 without passing through a polarizer may be polarized along the transmission axis of the first reflective element 2. This can increase the proportion of the second light L2 transmitted through the first reflective element 2.

The phase difference plate 7 may be, for example, a quarter-wavelength plate. The first light L1 polarized linearly or slightly elliptically along the transmission axis of the first reflective element 2 passes through the quarter-wavelength plate to be circularly polarized light that rotates in a first rotation direction. This circularly polarized light is retroreflected by the second reflective element 3 to be circularly-polarized second light L2 that rotates in a second rotation direction reverse to the first rotation direction. The circularly-polarized second light L2 passes through the quarter-wavelength plate to be linearly polarized light traveling in the direction intersecting with the transmission axis of the first reflective element 2. In other words, the second light L2 is polarized linearly along the reflective axis of the first reflective element 2. The use of the phase difference plate 7 allows the second light L2 to be polarized linearly or slightly elliptically in the direction intersecting with the first light L1. This can increase the reflectance of the second light L2 from the first reflective element 2. The aerial image can thus have higher resolution and higher brightness. This increases the amount of information presented by the aerial image to the user.

The phase difference plate 7 may be used in examples other than when the first reflective element 2 is a polarizer. For example, the phase difference plate 7 may be used to cause s-polarized second light L2 to be incident on the first reflective element 2. This allows use of a high reflectance near Brewster's angle.

The phase difference plate 7 may include a quarter-wavelength plate 7a and a half-wavelength plate 7b that is located between the quarter-wavelength plate 7a and the second reflective element 3 in the second direction D2. The phase difference plate 7 may have an intersection angle of, for example, 45° or an intersection angle close to 45° between the slow axis of the quarter-wavelength plate 7a and the slow axis of the half-wavelength plate 7b. In this case, the phase difference plate 7 may have constant retardation across a wide wavelength band. The phase difference plate 7 allows the second light L2 to be circularly polarized light across a wide wavelength band.

The first light L1 transmitted through the first reflective element 2 is polarized linearly in the polarization direction of the first reflective element 2. In the aerial image projector 1 including no phase difference plate 7, the second light L2 retroreflected by the second reflective element 3 may be polarized linearly or slightly elliptically in the polarization direction of the first reflective element 2. Thus, the second light L2 remaining polarized linearly or slightly elliptically may be incident on the first reflective element 2. This may increase the proportion of the second light L2 transmitted through the first reflective element 2. When the phase difference plate 7 is used to cause the second light L2 to be polarized circularly, the reflectance of the second light L2 from the first reflective element 2 can be increased. The aerial image can thus have higher resolution and higher brightness. This increases the amount of information presented by the aerial image to the user.

In the aerial image projector 1, the first light L1 emitted from the display device 8 may be polarized in the polarization direction of the first reflective element 2. This structure can increase the transmittance of the first light L1 through the first reflective element 2. This can thus increase the light use ratio of the aerial image projector 1 and increase the resolution and brightness of an aerial image, thus increasing the amount of information presented by the aerial image to the user. The structure may also reduce, while increasing the resolution of the aerial image, the light amount of the backlight 81 to reduce the power consumption of the aerial image projector 1.

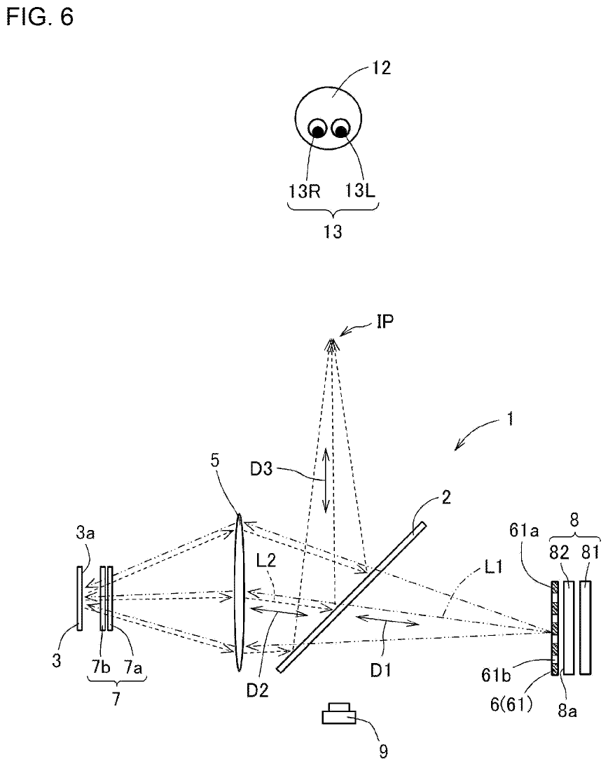

The aerial image projector 1 may include a camera 9 as illustrated in, for example, FIG. 6. The camera 9 may capture an image in the third direction D3 through the first reflective element 2.

The camera 9 may be a visible light camera or an infrared camera. The infrared light camera may be a far-infrared camera. The camera 9 may capture a visible light image and an infrared light image. The camera 9 may be a monocular camera or a stereo camera. The camera 9 may include a charge-coupled device (CCD) image sensor or a complementary metal-oxide semiconductor (CMOS) image sensor.

The camera 9 may capture an image of the user 12. The camera 9 may capture an image of the face of the user 12. The camera 9 may capture an image of the eyes 13 of the user 12. The aerial image projector 1 may detect the positions of the eyes 13 of the user 12 based on the captured image. The aerial image projector 1 may adjust, for example, the imaging position of an aerial image based on the detected positions of the eyes 13 of the user 12. This allows the user 12 at various positions to view an aerial image with high resolution. The camera 9 may capture an image of feature points included in the face of the user 12 for identifying the positions of the eyes 13 of the user 12, rather than capturing the image of the eyes 13 of the user 12. The feature points may include the user's eyebrows, nose, and lips.

The camera 9 may capture the image of the user 12 reflected by a reflection member such as a mirror through the first reflective element 2. This structure can increase the positioning flexibility of the camera 9.

The aerial image projector 1 may include no camera 9 and may be connected to an external camera external to the projector. The aerial image projector 1 may include an input terminal for receiving signals from the external camera. The external camera may be connected to the input terminal directly. The external camera may be connected to the input terminal indirectly through a shared network.

The positions of the eyes 13L and 13R of the user 12 may change depending on the body shape and posture of the user 12. In this case, the positions of the eyes 13L and 13R of the user 12 detected by the camera 9 may be used to change the light path of the first light L1 or the second light L2 and allow the user 12 to appropriately view the aerial image. To change the light path of the second light L2 reflected by the first reflective element 2, the aerial image projector 1 may change, for example, at least one of the position or orientation of the first reflective element 2.

The aerial image projector 1 may include a drive that changes at least one of the position or orientation of the first reflective element 2. The operation of the drive may be controlled by the controller. The drive may translate the first reflective element 2 in the first direction D1 to change the position of the first reflective element 2. The drive may rotate the first reflective element 2 about one or two rotation shafts included in the first reflective element 2 to change the orientation of the first reflective element 2. This structure can change at least one of the position at which the second light L2 reflected by the first reflective element 2 forms an image or the traveling direction of the second light L2 reflected by the first reflective element 2 (specifically, the third direction D3). The light path of the second light L2 can thus be changed in accordance with the position of the eyes 13 of the user 12 to allow the user to appropriately view the aerial image.

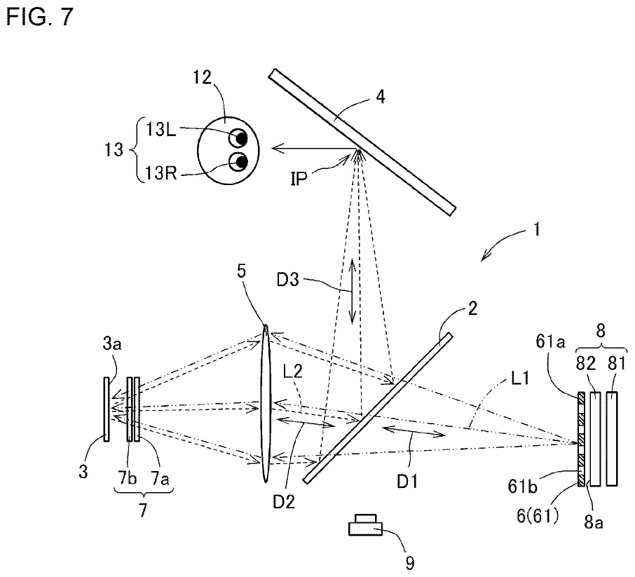

The aerial image projector 1 may include a third reflective element 4 as illustrated in, for example, FIG. 7. The third reflective element 4 may reflect the second light L2 reflected by the first reflective element 2 toward the user. This structure allows the user to view the aerial image at positions in various directions. The third reflective element 4 may be a mirror including, for example, glass or a light reflective resin. When the aerial image projector 1 is mounted on a movable body including a windshield, the windshield may serve as the third reflective element 4.

The camera 9 may capture an image of the user reflected by the third reflective element 4 through the first reflective element 2. This increases the positioning flexibility of the camera 9 and allows capturing of an image of the user.

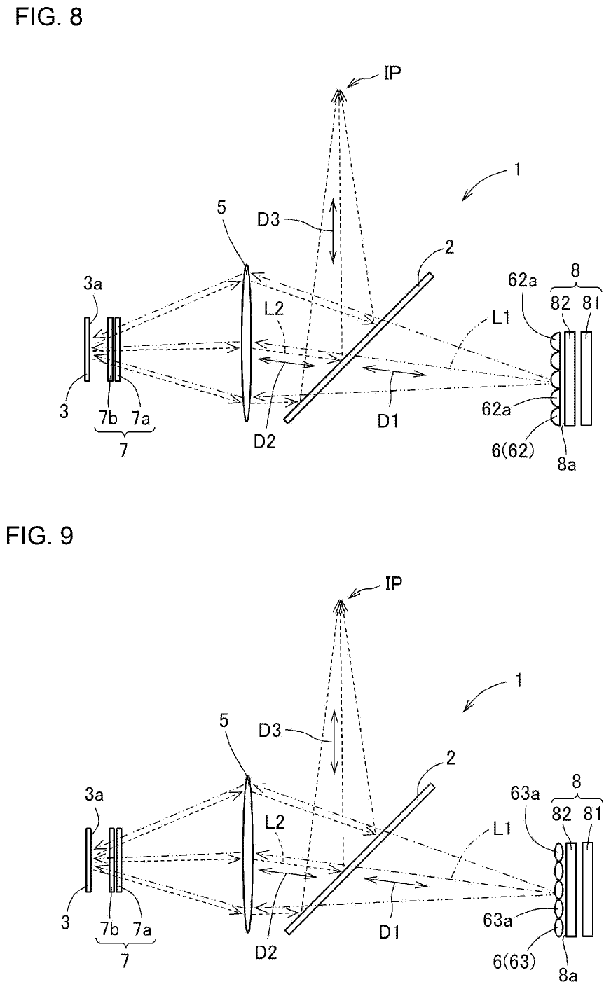

Although the second optical element 6 includes the parallax barrier 61 in the example described above, the second optical element 6 may include a lenticular lens 62 as illustrated in, for example, FIG. 8. The lenticular lens 62 may include, for example, multiple semicircle cylindrical lenses 62a that extend in a predetermined direction and are arranged in a direction orthogonal to the predetermined direction. For the second optical element 6 including the lenticular lens 62, the aerial image projector 1 can form a three-dimensional aerial image and increase the amount of information presented by the aerial image to the user, as in the example in which the second optical element 6 includes the parallax barrier 61.

The second optical element 6 may include a microlens array 63 as illustrated in, for example, FIG. 9. The microlens array 63 includes, for example, multiple microlenses 63a arranged in a matrix. Each of the microlenses 63a may be, for example, a biconvex lens, a plano-convex lens, or a meniscus lens. For the second optical element 6 including the microlens array 63, the aerial image projector 1 can form a three-dimensional aerial image and increase the amount of information presented by the aerial image to the user, as in the example in which the second optical element 6 includes the parallax barrier 61.

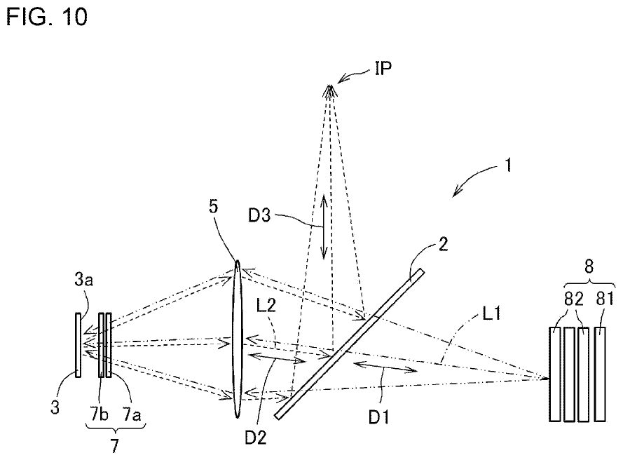

The aerial image projector 1 may include a stacked display device as the display device 8 as illustrated in, for example, FIG. 10. The stacked display device may include, for example, the backlight 81 and multiple liquid crystal panels 82. The multiple pixels in the liquid crystal panels 82 emit beams, which form images at different imaging positions IP in the air to form a three-dimensional aerial image. This can increase the amount of information presented by the aerial image to the user. For the display device 8 being a stacked display device, the aerial image projector 1 may eliminate the second optical element 6. The aerial image projector 1 illustrated in FIG. 10 allows the user to view the three-dimensional aerial image at various viewing points. The aerial image projector 1 illustrated in FIG. 10 allows multiple users to view the three-dimensional aerial image.

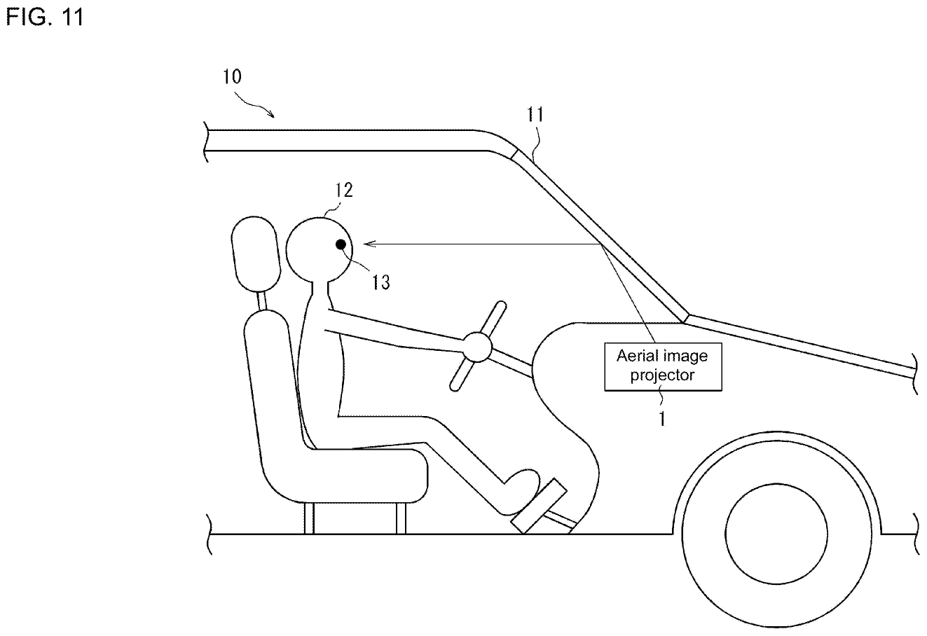

The aerial image projector 1 may be mounted on a movable body 10 as illustrated in, for example, FIG. 11.

In one or more embodiments of the present disclosure, examples of the movable body include a vehicle, a vessel, and an aircraft. Examples of the vehicle include an automobile, an industrial vehicle, a railroad vehicle, a community vehicle, and a fixed-wing aircraft traveling on a runway. Examples of the automobile include a passenger vehicle, a truck, a bus, a motorcycle, and a trolley bus. Examples of the industrial vehicle include an industrial vehicle for agriculture and an industrial vehicle for construction. Examples of the industrial vehicle include a forklift and a golf cart. Examples of the industrial vehicle for agriculture include a tractor, a cultivator, a transplanter, a binder, a combine, and a lawn mower. Examples of the industrial vehicle for construction include a bulldozer, a scraper, a power shovel, a crane vehicle, a dump truck, and a road roller. Examples of the vehicle may include man-powered vehicles. The classification of the vehicle is not limited to the above examples. Examples of the automobile include an industrial vehicle traveling on a road. One type of vehicle may fall within multiple classes. Examples of the vessel include a jet ski, a boat, and a tanker. Examples of the aircraft include a fixed-wing aircraft and a rotary-wing aircraft.

In the example of FIG. 11, the movable body 10 is a passenger vehicle. The movable body 10 may be any of the above examples instead of a passenger vehicle. The aerial image projector 1 may be at any position inside or outside the movable body 10. For example, the aerial image projector 1 may be inside a dashboard in the movable body 10. In the aerial image projector 1, the second light L2 reflected by the first reflective element 2 may be reflected by the windshield 11 as the third reflective element 4 and be incident on the eyes 13 of the user 12. This structure allows the user 12 to view a three-dimensional aerial image. The movable body 10 on which the aerial image projector 1 is mounted can increase the amount of information presented by the aerial image to the user.

In the present disclosure, the first, the second, or others are identifiers for distinguishing the components. The identifiers of the components distinguished with the first, the second, and others in the present disclosure are interchangeable. For example, the first reflective element can be interchangeable with the second reflective element. The identifiers are to be interchanged together. The components for which the identifiers are interchanged are also to be distinguished from one another. The identifiers may be eliminated. The components without such identifiers can be distinguished with reference numerals. The identifiers such as the first and the second in the present disclosure alone should not be used to determine the order of components or to suggest the existence of smaller or larger number identifiers.

The present disclosure may be implemented in the following forms.

In one embodiment of the present disclosure, an aerial image projector includes a first reflective element, a second reflective element, a first optical element, a display device, and a second optical element. The first reflective element transmits, in a second direction, a part of first image light traveling in a first direction and reflects, in a third direction, a part of second image light traveling in the second direction. The second reflective element retroreflects the first image light transmitted through the first reflective element as the second image light. The first optical element is between the first reflective element and the second reflective element. The first optical element collects the first image light and the second image light. The display device is located apart from the first reflective element in the first direction. The display device emits the first image light. The second optical element divides a beam of the first image light emitted from the display device into at least two light beams.

In one embodiment of the present disclosure, a movable body includes the aerial image projector described above.

In one embodiment of the present disclosure, the aerial image projector can increase the amount of information presented by the aerial image to the user. In one embodiment of the present disclosure, the movable body can increase the amount of information presented by the aerial image to the user.

Although embodiments of the present disclosure have been described in detail, the present disclosure is not limited to the embodiments described above, and may be changed or varied in various manners without departing from the spirit and scope of the present disclosure. The components described in the above embodiments may be entirely or partially combined as appropriate unless any contradiction arises.

### REFERENCE SIGNS

1 aerial image projector
2 first reflective element
3 second reflective element
3a reflective surface
4 third reflective element
5 first optical element
6 second optical element
61 parallax barrier
61a light-blocking portion
61b open area
62 lenticular lens
62a cylindrical lens
63 microlens array
63a microlens
7 phase difference plate
7a quarter-wavelength plate
7b half-wavelength plate
8 display device
8a display surface
81 backlight
82 liquid crystal panel
820 black matrix
820a first black line
820b second black line
9 camera
10 movable body
11 windshield
12 user
13 eye
13L first eye (left eye)
13R second eye (right eye)
14 third optical element

1. An aerial image projector comprising:
a first reflective element configured to transmit, in a second direction, a part of first image light traveling in a first direction and reflect, in a third direction, a part of second image light traveling in the second direction;
a second reflective element configured to retroreflect the first image light transmitted through the first reflective element as the second image light;
a first optical element between the first reflective element and the second reflective element, the first optical element being configured to collect the first image light and the second image light;
a display device located apart from the first reflective element in the first direction, the display device being configured to emit the first image light; and
a second optical element configured to divide a beam of the first image light emitted from the display device into at least two light beams.

2. The aerial image projector according to claim 1, wherein
the first reflective element includes a reflective polarizer.

3. The aerial image projector according to claim 1, wherein
the at least two light beams include a first partial light beam to be incident on a first eye of a user and a second partial light beam to be incident on a second eye of the user.

4. The aerial image projector according to claim 1, further comprising:
a camera configured to capture an image in the third direction through the first reflective element.

5. The aerial image projector according to claim 1, wherein
the second reflective element is adjacent to a focal point of the first optical element.

6. The aerial image projector according to claim 1, wherein
the display device is adjacent to a focus of the first optical element.

7. The aerial image projector according to claim 1, further comprising:
a third optical element between the second reflective element and the first optical element, the third optical element being configured to collect light.

8. The aerial image projector according to claim 1, further comprising:
a phase difference plate between the second reflective element and the first optical element, the phase difference plate being configured to rotate a polarization direction of transmitted light.

9. The aerial image projector according to claim 8, wherein
the phase difference plate includes a quarter-wavelength plate and a half-wavelength plate, and the half-wavelength plate is between the quarter-wavelength plate and the second reflective element.

10. The aerial image projector according to claim 1, further comprising:
a third reflective element configured to reflect the second image light reflected by the first reflective element toward a user.

11. A movable body comprising:
the aerial image projector according to claim 1.
